(19) United States
(12) Patent Application Publication
(10) Pub. No.: US 2026/0331939 A1
(43) Pub. Date: Oct. 22, 2026

(54) ENERGY STORAGE MANAGEMENT IN HIGH CYCLING APPLICATION

(71) Applicant: Vertiv Corporation, Westerville, OH (US)

(72) Inventor: William Dixon, Lewis Center, OH (US)

(21) Appl. No.: 19/462,223

(22) Filed: Jan. 28, 2026

Related U.S. Application Data
(60) Provisional application No. 63/792,666, filed on Apr. 22, 2025.

(51) Int. Cl. H02J 7/90; H02J 7/94; H02J 7/96

(52) U.S. Cl. CPC H02J 7/933; H02J 7/94; H02J 7/96; H02J 7/977; H02J 2207/20

(57) ABSTRACT

A monitoring and management system is provided including a converter, an energy storage unit, and a controller operatively coupled to the energy storage unit and the converter. The controller receives data of a plurality of status indicators of the energy storage unit; calculates an index based on the plurality of status indicators; compares the index to a threshold value; and controls the converter to increase or decrease an output current level based on the comparison of the index to the threshold value.

### CROSS-REFERENCE TO RELATED APPLICATIONS

This application claims the benefit of U.S. Provisional Application 63/792,666, filed Apr. 22, 2025, the entire disclosure of which and all attachments thereto are incorporated herein by reference in their entireties.

### BACKGROUND

### 1. Field

Apparatuses and methods consistent with example embodiments relate to energy storage management and, more specifically, to energy monitoring and management.

### 2. Background

Data center and telecommunication operators are continuously growing their infrastructure in order to keep pace with the demanded increase in data traffic and computing. Customers are deploying more and more graphics processing units (GPU) clusters in their data centers. However, such GPU clusters present the problem of potentially large and repetitive load swings. High-density artificial intelligence (AI) computing systems also have load profiles that can create problems in upstream equipment such as early failure, failure to maintain voltage and frequency regulation in the building, and visible light flicker.

Converters are crucial in data centers for transforming and conditioning power, ensuring the reliable and efficient operation of equipment, especially with a move towards higher power density and distribution. Energy storage can be deployed with a power converter near the load to source and sink power above and below a time-average load power demand, which aids in shielding upstream equipment from these problems. However, energy storage elements such as batteries and capacitors have limitations which must be respected by the power converter in order to avoid premature failure of the energy storage element.

With respect to the location of power converters, many customers want distributed power conversion equipment while many others want a large, central uninterruptable power supply (UPS).

Furthermore, energy storage elements when deployed with power converters to perform this power smoothing or load leveling task are constantly seen charging or discharging current. With respect to single or parallel converters, problems that may occur include: a converter overdriving an energy storage element to a temperature, current, or voltage safety trip level, requiring intervention and reset; a converter may “lightly” overdrive an energy storage element to a temperature or voltage which reduces life or backup runtime below customer expectations; and a converter may suddenly stop performing power smoothing to avoid overdriving and energy storage element. With respect to parallel converters, load sharing may pose a problem. There are design approaches for load sharing including droop control (open loop, higher load lower target output voltage; and a shared analog or digital signal line used as an input to control loop. However, when a load is changing quickly and constantly, load sharing may still be poor. The life of an energy storage element is mostly determined by how aggressively it’s used, and the service life of each converter’s energy storage element may thus be imbalanced. FIGS. 1A-1E, 2A and 2B illustrate example problems for single or parallel converters.

Finally, power conversion and the efficient use of power converters is also at the core of reducing the energy consumption of data centers.

### SUMMARY

Example embodiments may address at least the above such drawbacks and/or disadvantages and other disadvantages not described above. Also example embodiments are not required to overcome the disadvantages described above, and may not overcome any of the problems described above.

According to an example implementation of an example embodiment, a power monitoring and management system may comprise: an energy storage unit; a converter operatively coupled to the energy storage unit; and a controller operatively coupled to the energy storage unit and the converter, the controller comprising a memory storing instructions thereon and a processor configured to execute the instructions and thereby: receive data of a plurality of status indicators of the energy storage unit; calculate an index based on the plurality of status indicators; compare the index to a threshold value; control the converter to decrease an output current level in a case in which the index is higher than the threshold value; and control the converter to increase the output current level in a case in which the index is lower than the threshold value.

According to an example implementation, the system may further comprise: a monitor system comprising at least one sensor communicatively coupled to the controller and configured to sense at least one of the plurality of status indicators and to transmit data of the at least one of the plurality of status indicators to the controller.

According to an example implementation, the plurality of status indicators may comprise at least two of: an energy storage element temperature Δ_T, a cell voltage sample variance Δ_VVc, a current sample variance Δ_Iv, and an instantaneous current I_inst; and calculation of the index comprises weighting each of the plurality of status indicators and summing the weighted status indicators.

According to an example implementation, Δ_T may be a battery temperature of the energy storage unit less a highest battery temperature averaged over a polling interval; Δ_VVc may be a battery cell voltage variance of the energy storage unit less a highest battery cell voltage variance averaged over the polling interval; Δ_Iv may be a battery current variance of the energy storage unit less a highest battery current variance averaged over the polling interval; and I_inst may be an instant battery current of the energy storage unit less a highest allowable battery current.

According to an example implementation of an example embodiment, a power monitoring and management system may comprise: a plurality of energy storage units; a plurality of converters, each of the plurality of converters operatively coupled to a corresponding one of the plurality of energy storage units; at least one controller operatively coupled to the plurality of energy storage units and to the plurality of converters, the at least one controller comprising a memory storing instructions thereon and a processor configured to execute the instructions and thereby, for each one of the plurality of converters: receive data of a plurality of status indicators of a corresponding one of the plurality of energy storage units; calculate an index based on the plurality of status indicators; compare the index to a threshold value; control the converter to decrease an output current level in a case in which the index is higher than the threshold value; and control the converter to increase the output current level in a case in which the index is lower than the threshold value.

According to an example implementation, the system may further comprise: a monitor system comprising a plurality of sensors, wherein each of the plurality of sensors is communicatively coupled to one of the plurality of converters and configured to sense at least one of the plurality of status indicators and to transmit data of the at least one of the plurality of status indicators to the at least one controller.

According to an example implementation, the plurality of status indicators may comprise at least two of: an energy storage element temperature Δ_T, a cell voltage sample variance Δ_VVc, a current sample variance Δ_Iv, and an instantaneous current I_inst; and calculation of the index comprises weighting each of the plurality of status indicators and summing the weighted status indicators.

According to an example implementation, Δ_T may be a battery temperature of the energy storage unit less a highest battery temperature averaged over a polling interval; Δ_VVc may be a battery cell voltage variance of the energy storage unit less a highest battery cell voltage variance averaged over the polling interval; Δ_Iv may be a battery current variance of the energy storage unit less a highest battery current variance averaged over the polling interval; and I_inst may be an instant battery current of the energy storage unit less a highest allowable battery current.

According to an example implementation of an example embodiment, a power monitoring and management method may comprise: at least one sensor sensing a plurality of status indicators of each of a plurality of energy storage units and transmitting the plurality of status indicators to at least one controller; for each of the plurality of energy storage units, the controller calculating a corresponding index based on the plurality of status indicators and comparing the index to a threshold value; for each of the plurality of energy storage units, in a case in which the corresponding index is higher than the threshold value, decreasing an output current level of a converter operatively coupled to the energy storage unit; and for each of the plurality of energy storage units, in a case in which the corresponding index is lower than the threshold value, increasing an output current level of a converter operatively coupled to the energy storage unit.

According to an example implementation, the plurality of status indicators may comprise at least two of: an energy storage element temperature Δ_T, a cell voltage sample variance Δ_VVc, a current sample variance Δ_Iv, and an instantaneous current I_inst; and the calculating the corresponding index comprises weighting each of the plurality of status indicators and summing the weighted status indicators.

According to an example implementation, Δ_T may be a battery temperature of the energy storage unit less a highest battery temperature averaged over a polling interval; Δ_VVc may be a battery cell voltage variance of the energy storage unit less a highest battery cell voltage variance averaged over the polling interval; Δ_Iv may be a battery current variance of the energy storage unit less a highest battery current variance averaged over the polling interval; and I_inst may be an instant battery current of the energy storage unit less a highest allowable battery current.

### BRIEF DESCRIPTION OF THE DRAWINGS

The above and other objects, advantages, and salient features will become apparent to those skilled in the art from the following detailed description of example embodiments when taken in conjunction with the accompanying drawings in which:

FIGS. 1A-1E, 2A and 2B illustrate example problems for single or parallel converters;

FIG. 3 is a schematic illustration of a data center layout including a power supply system according to an example embodiment;

FIG. 4 is a schematic illustration of a portion of a power supply system according to an example embodiment;

FIG. 5 is a schematic illustration of a controller according to an example embodiment; and

FIG. 6 is a flow chart of a monitoring and management method according to an example embodiment.

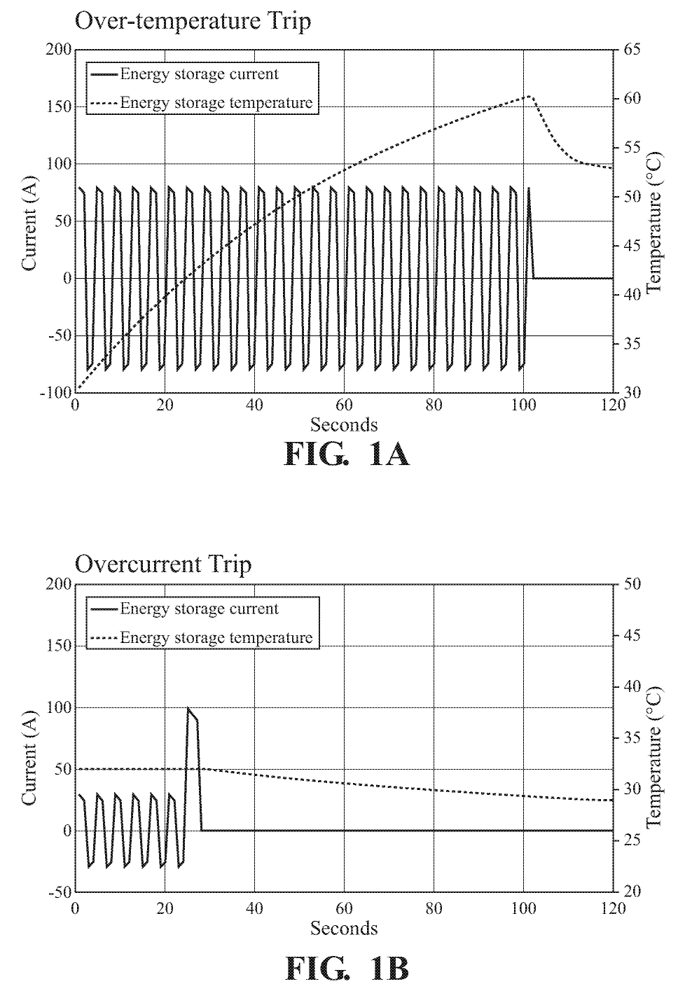

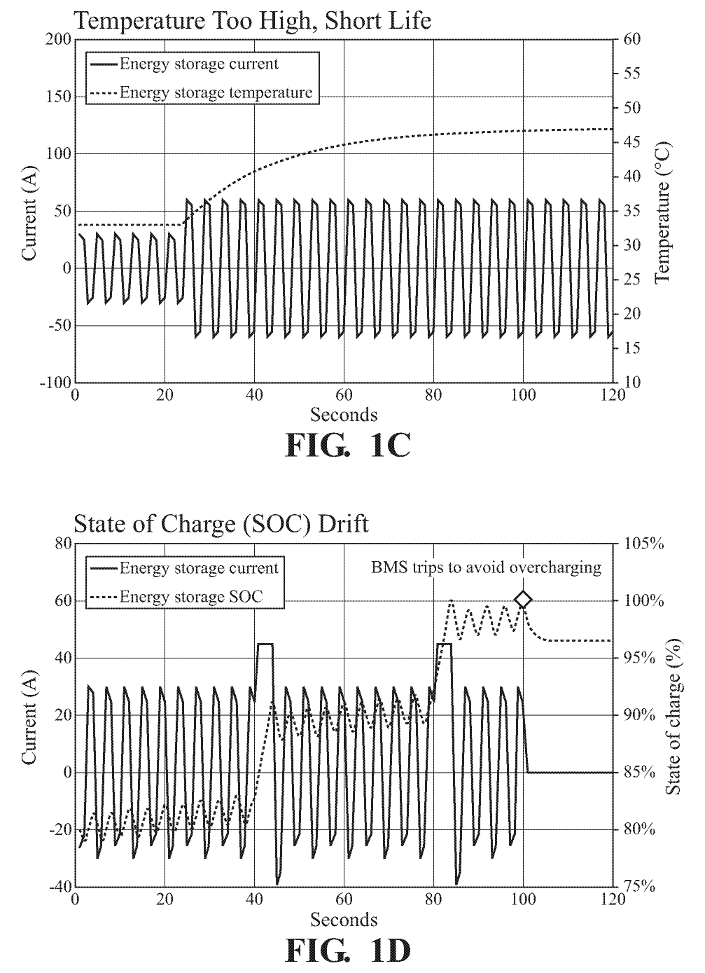

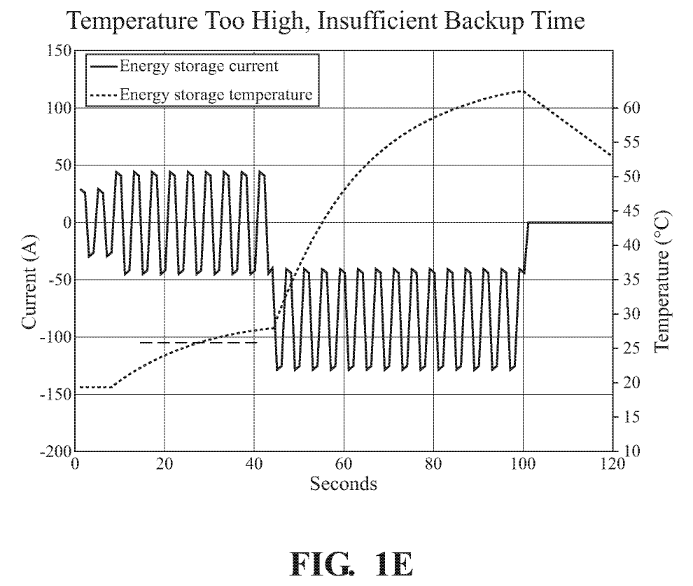

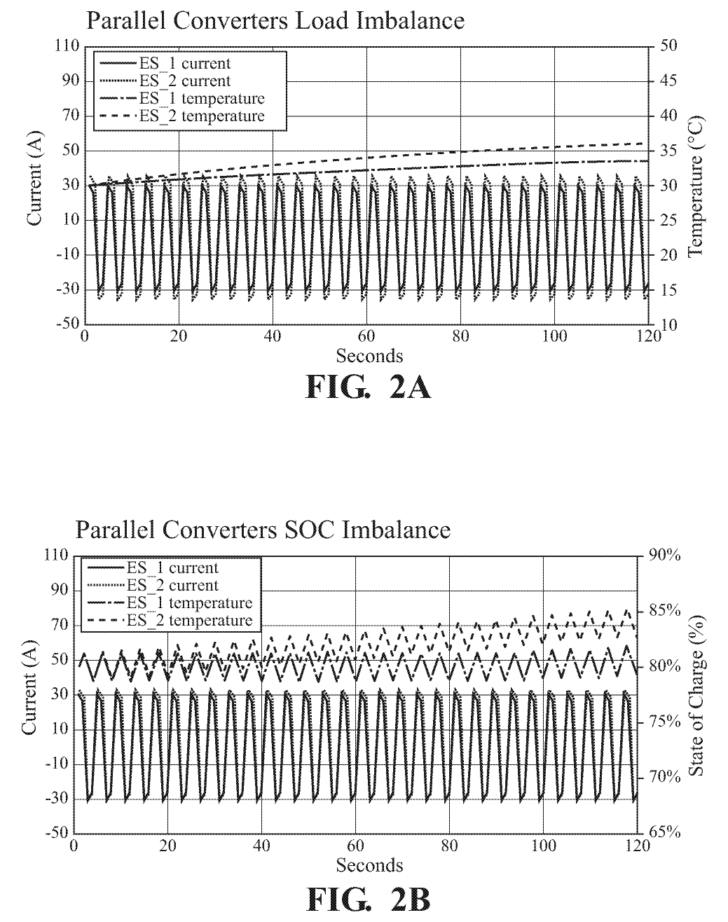

### DETAILED DESCRIPTION

Reference will now be made in detail to example embodiments which are illustrated in the accompanying drawings, wherein like reference numerals refer to like elements throughout. In this regard, the example embodiments may have different forms and may not be construed as being limited to the descriptions set forth herein.

It will be understood that the terms “include,” “including”, “comprise, and/or “comprising,” when used in this specification, specify the presence of stated features, integers, steps, operations, elements, and/or components, but do not preclude the presence or addition of one or more other features, integers, steps, operations, elements, components, and/or groups thereof.

It will be further understood that, although the terms “first,” “second,” “third,” and/or other, may be used herein to describe various elements, components, regions, layers and/or sections, these elements, components, regions, layers and/or sections may not be limited by these terms. These terms are only used to distinguish one element, component, region, layer or section from another element, component, region, layer or section.

As used herein, the term “and/or” includes any and all combinations of one or more of the associated listed items. Expressions such as “at least one of,” when preceding a list of elements, modify the entire list of elements and do not modify the individual elements of the list.

Various terms are used to refer to particular system components. Different companies may refer to a component by different names – this document does not intend to distinguish between components that differ in name but not function.

Matters of these example embodiments that are obvious to those of ordinary skill in the technical field to which these example embodiments pertain may not be described here in detail.

As discussed above, many customers want distributed power conversion equipment while many others want a large, central uninterruptable power supply (UPS), and power smoothing can be performed by both.

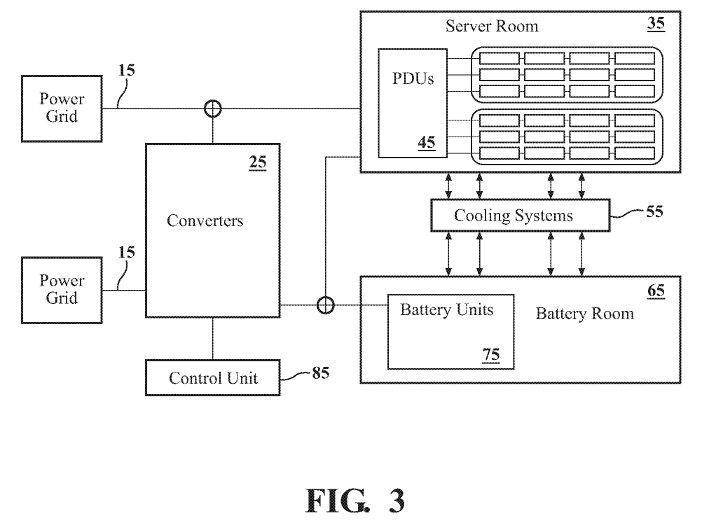

FIG. 3 is a schematic illustration of a data center layout including a power supply system according to an example embodiment. The layout illustrates power grid inputs 15, converters 25, power distribution units 45 within a server room 35, the cooling systems 55, and batteries 75 within a battery room 65. A control unit 85 is operatively connected to the converters 25. The control unit 85 may be a main control unit operatively connected to individual control units with or coupled to each respective individual converter (not shown). The control unit 85 combined with individual control units of each converter functions to monitor and control connections, currents, voltages, and current loads within the power supply system.

### Power Supply System

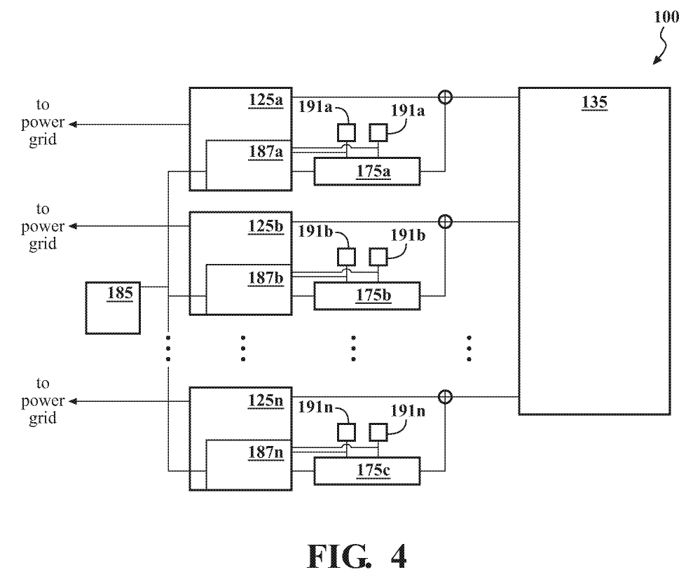

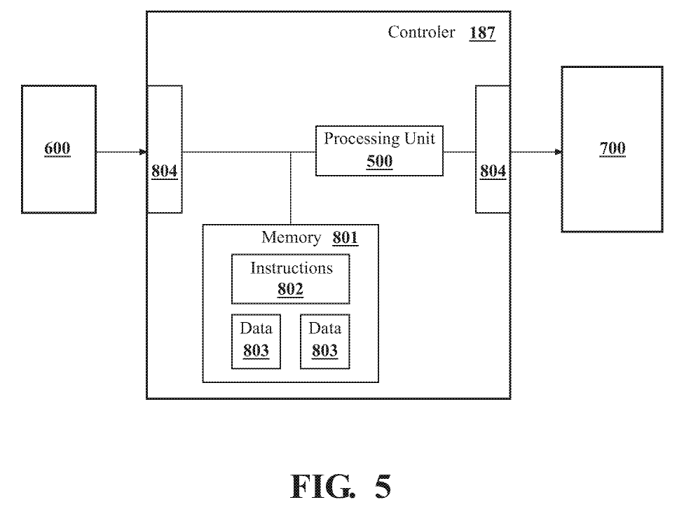

FIG. 4 is a schematic illustration of a portion of a power supply system 100 according to an example embodiment. According to this example embodiment, the power supply system 100 includes battery units 175, each battery unit including one or more battery, to control power supply to a server room 135 for example. A converter 125 is operatively connected between each battery unit 175 and the power grid. Furthermore, a controller 187 is operatively connected to each battery unit 175. The controllers 187 may each be operatively connected to or disposed within a corresponding one of the converters 125. Each controller 187 may be operatively coupled to each other controller 187 in order to exchange data, for example, and the controllers 187 may be connected to a system controller 185.

The system may further include a monitor system including one or more sensors 191 configured to obtain data of the battery units 175 and provide the same to a corresponding controller 187. The monitor system is discussed in further detail below.

### Monitor System

According to one or more example embodiments, the power supply system may include a monitor system configured to sense or otherwise obtain data of the battery units 175. The monitor system may include one or more sensors 191, as shown in FIG. 4. The sensors 191 may be positioned, for example, as illustrated in FIG. 4, and may each be communicatively coupled to one or more of the battery units 175 and one or more of the controllers 187. The sensors 191 may include, for example, temperature sensors, voltmeters, current probes and/or current transducers, and any of various other sensors, as would be understood by one of skill in the art.

Each of the sensors 191 may be configured to obtain data of one or more of the battery units 175, the data including, but not limited to: instantaneous cell voltage, instantaneous cell current, instantaneous cell temperature, cell voltage variance, cell current variance, cell temperature variance, and any other of a variety of data as would be understood by one of skill in the art.

According to an example embodiment, a sensor 191 may be configured to determine one or more of energy storage element temperature Δ_T (e.g. where Δ_T is an own battery temperature less a highest battery temperature averaged over a polling interval of, for example, five seconds), cell voltage sample variance Δ_VVc (e.g. where Δ_VVc is an own battery cell voltage variance less a highest battery cell voltage variance averaged over the polling interval), current sample variance Δ_Iv (e.g. where Δ_Iv is an own battery current variance less a highest battery current variance averaged over the polling interval), and instantaneous current I_inst (e.g. where I_inst is an instantaneous reading of an own battery current less a highest allowable battery current), and to provide such data to a controller 187.

The sensors 191 may be configured to output data continuously, or at a predetermined interval or at predetermined times, as would be understood by one of skill in the art.

### Control System

According to one or more example embodiments, the power supply system 100 may include a control system 800 configured to obtain information from the sensor(s) 191 of the monitor system and, based on the information, control an output current of one or more converters 125. The control system 800 includes the plurality of controllers 187.

The data provided to each controller 187 serves as indicator(s) of how aggressively energy storage is being used by the associated converter 125. A controller 187 may, for example, use the information from one or more sensors 191, as well as data shared among the controllers 187 to control the associated converter 125 to facilitate the maintenance of the temperature and cell voltage variance of its energy storage element to be substantially the same as the temperature and cell voltage variance of other, parallel converters 125.

FIG. 5 is a schematic illustration of a controller 187. As shown in FIG. 5, a the each controller 187 may be a computer including a processing unit 500, a system memory 801, and a system bus (not shown). The system bus provides interconnections among the control system components. The processing unit 500 can be any of various available processors. Dual microprocessors and other multiprocessor architectures also can be employed as the processing unit 500.

The system bus can be any of several types of bus structures providing operative connections among the elements of the control system 800 including, but not limited to, a memory bus or memory controller, a peripheral bus or external bus, and/or a local bus using any of a variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 801 may include volatile memory and nonvolatile memory. A basic input/output system (BIOS), containing basic routines to transfer information among elements of the control system 800, such as during start-up, may be stored in nonvolatile memory. By way of non-limiting example, nonvolatile memory may include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory may include random access memory (RAM), which may act as an external cache memory. By way of non-limiting example, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

The control system 800 may also include removable and/or non-removable, volatile and/or non-volatile computer storage media, for example, a disk storage. A disk storage may include, but is not limited to, a magnetic disk drive, floppy disk drive, tape drive, Jaz drive, Zip drive, LS-100 drive, flash memory card, and a memory stick. Disk storage also may include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices to a system bus, a removable or non-removable interface may be used.

The control system can be implemented, at least in part, in digital electronic circuitry, analog electronic circuitry, or in computer hardware, firmware, software, or a combination thereof. Accordingly, the control system 800 may be implemented, at least in part as a computer program product such as a computer program, program code or computer instructions tangibly stored in the system memory 801 and executed by the processing unit 500. The control system may obtain information from one or more sensors 191 of the monitor system, via one or more input/output units 804. The information may be stored as data, for example in the memory 801 in the and, based on the information from the one or more sensors 191, the processing unit 500 may process and output data and/or control instructions, also via the one or more input/output units 804. The one or more input/output units 804 may be communicatively and operationally connected, either individually or in groups to a converter 125 correspondingly coupled to the controller 187, via wired or wireless connection. Of course, as would be understood by one of skill in the art, the control system 800 may alternately be implemented, for example, as a computer program product such as a computer program, program code or computer instructions tangibly embodied in another type of information carrier, or in a machine-readable storage device, for execution by, or to control the operation of, another type of data processing apparatus such as a programmable processor, a computer, multiple computers, or a programmable logic controller (PLC).

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or other device or on multiple device at one site or distributed across multiple sites and interconnected by a communication network. Also, functional programs, codes, and code segments for accomplishing features described herein can be easily developed by programmers skilled in the art. Operations associated with the example embodiments can be performed by one or more programmable processors executing a computer program, code or instructions to perform functions (e.g., by operating on input data and/or generating an output). Operations can also be performed by, and apparatuses described herein can be implemented as, special purpose logic circuitry, e.g., a field programmable gate array (FPGA) or an application-specific integrated circuit (ASIC), for example.

A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., electrically programmable read-only memory (ROM) (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory can be supplemented by, or incorporated in special purpose logic circuitry.

Computer-readable non-transitory media includes all types of computer readable media, including magnetic storage media, optical storage media, flash media and solid state storage media. It should be understood that software can be installed in and sold with a central processing unit (CPU) device. Alternately, software can be obtained and loaded into the CPU device, including obtaining the software through physical medium or distribution system, including, for example, from a server owned by the software creator or from a server not owned but used by the software creator. The software can be stored on a server for distribution over the Internet, for example.

Sensors 191 of the monitor system may be communicatively and operationally connected, either individually or in groups of one or more sensors 191 to one or more battery units 175 of the power supply system 100, and/or to one or more other elements of the power control system 100. Such connections may be via wired or wireless connections either separately to individual elements or to groups of elements. Wireless connections may be, for example, via antennas, Bluetooth or Bluetooth Low Energy (BLE), Near-Field Communication (NFC), or another means, as would be understood by one of skill in the art. The controllers 187 may be communicatively and operationally connected to sensors 191 via wired or wireless connections either to the monitor system as a whole, including all of the sensors 191, or separately to individual sensors or groups of sensors of the monitor system. Wireless connections may be, for example, via antennas, Bluetooth or Bluetooth Low Energy (BLE), Near-Field Communication (NFC), or another means, as would be understood by one of skill in the art. The controllers 187 may also be communicatively and operationally connected to any one or more sensors 191, via wired or wireless connections either to multiple sensors together, or separately to each individual sensor. As with other connections, wireless connections to one or more individual sensors 191 of the monitor system may be, for example, via antennas, Bluetooth or Bluetooth Low Energy (BLE), Near-Field Communication (NFC), or another means, as would be understood by one of skill in the art.

The controller 187 may also be communicatively and operationally connected to any one or more components, for example individual sensors, batteries, battery units, and converters via wired or wireless connections either to multiple components together, separately to each individual component, or separately to independent elements within a component. Wireless connections to one or more individual components may be, for example, via antennas, Bluetooth or Bluetooth Low Energy (BLE), Near-Field Communication (NFC), or another means, as would be understood by one of skill in the art.

According to one or more example embodiments, each of the controllers 187 independently, may execute one or more energy monitoring and management algorithms.

As described with respect to FIGS. 4 and 5, an individual controller 187 may be communicatively and operationally connected to each converter 125, and thus, each individual controller 187 may execute one or more energy monitoring and management algorithms, as discussed hereinbelow.

According to an alternate example embodiment, the individual controllers 187 may each be coupled to a system controller 185, which receives data from the sensors 191 of the monitor system via one or more of the individual controllers 187, such that the one or more energy monitoring and management algorithms may be executed by the system controller 185 or by a combination of the system controller 185 and one or more of the individual controllers 187.

According to another alternate example embodiment, a power supply system 100 may include a single system controller 185 coupled to the sensors 191, such that the system controller 185 may receive data from each of the sensors 191 directly and the one or more energy monitoring and management algorithms may be executed by the system controller 185.

### Example Operations

According to one or more example implementations, a control loop may be naturally slow due to the inertia of sensor inputs. However, this must be balanced with the fact that the long-term health of the energy storage may be at stake.

First example implementation: According to one or more example implementations, data of Δ_T, Δ_VVc, Δ_Iv, and I_inst may be obtained from one or more sensors 191, weighting factors may be applied to the data, and the weighted data may then be compared to a threshold to determine whether to output a virtual battery abuse sensor alert. For example, a weighting factor may be applied to each of Δ_T, Δ_VVc, and Δ_Iv; a weighting factor may be applied to I_inst; and the sum of the weighted data may be taken as a battery abuse index BAT_ABUSE_INDEX. The weighting factor applied to Δ_T, Δ_VVc, and Δ_Iv may be, for example 0.2-0.6, but this is merely an example, and the weighting factor may be determined as would be understood by one of skill in the art. The weighting factor applied to I_inst may be, for example, 1.0 if true and 0.0 if false, but this is merely an example, and the weighting factor may be determined as would be understood by one of skill in the art. The BAT_ABUSE_INDEX may, for example, fall in a range of -1 to 1, but this is merely an example, and the BAT_ABUSE_INDEX may be determined according to the weighting factors used. The BAT_ABUSE_INDEX may then be compared to a threshold scale. In a non-limiting example in which the BAT_ABUSE_INDEX falls in a range of -1 to 1, in the threshold scale, 0 may indicate substantially equal use of converter batteries, a positive number approaching 1 may indicate use of an own battery more aggressively than other converters, and a negative number approaching -1 may indicate use of an own battery less aggressively than other converters, for example.

In operation, when a converter 125, via its associated controller 187, is performing power smoothing according to one or more example embodiments, a cycle of obtaining data, weighting the data, summing the weighted data, and comparing the summed, weighted data to a threshold may be performed, for example at a polling interval of 1-5 seconds. Power smoothing may be defined as when the power converter has a time-varying load at its output, an upstream power source at its input, an energy storage bank connected at a midpoint between the input and output; when the load demand goes down, the converter 125 takes energy from the input source and pushes it into the energy storage bank, and when the load demand goes up, the converter 125 pulls energy out of the energy storage bank and sends it to the load. According to an example, a result may be that the input source sees less, or none, of the variation in demand presented by the load. At each polling interval, the converter/controller may adjust output current to be lower in the case of a positive BAT_ABUSE_INDEX, and the converter/controller may adjust output current to be higher in the case of a negative BAT_ABUSE_INDEX.

Second example implementation: According to a second example embodiment, data of Δ_T, Δ_VVc, Δ_Iv, and I_inst may be obtained from one or more sensors 191 in addition to data used in other current sharing controls, such as droop control and an analog current sharing signal and combined, for example as weighted, and the combination of this data may be used to determine the BAT_ABUSE_INDEX and to control an adjustment of the output current.

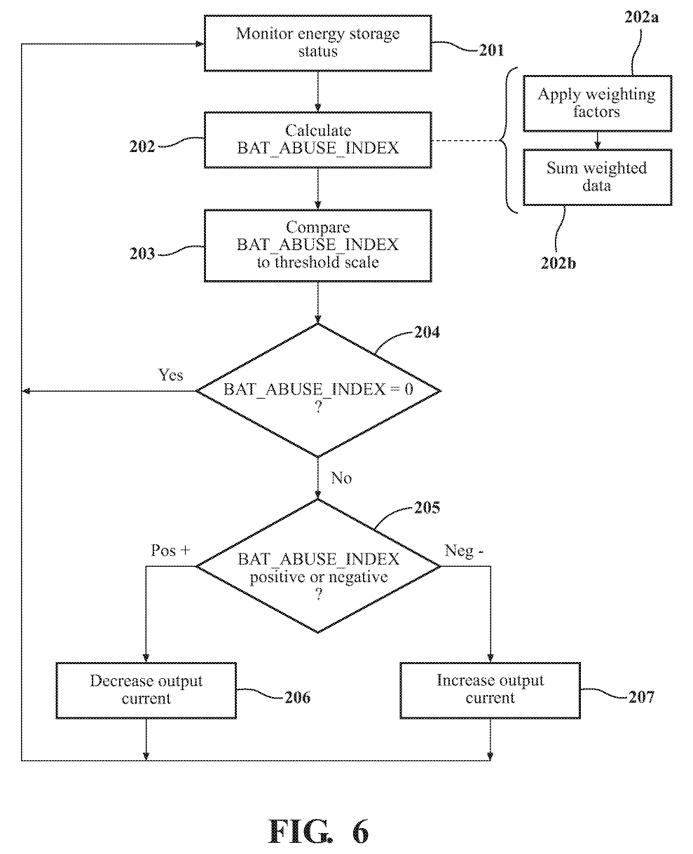

FIG. 6 is a flow chart of a monitoring and management method according to an example embodiment. The method may be executed by one or more controllers 187, by a system controller 185, or by any combination of one or more controllers 187 and the system controller 185, according to any example embodiment described herein, by means of an algorithm, for example. According to an example embodiment a monitoring and management method may include: monitoring energy storage status (201); calculating BAT_ABUSE_INDEX (202); comparing the BAT_ABUSE_INDEX to a threshold scale (203); determining whether the BAT_ABUSE_INDEX is zero, is positive, or is negative (204, 205); decreasing an output current based on the BAT_ABUSE_INDEX being positive (206); and increasing an output current based on the BAT_ABUSE_INDEX being negative (207). The entire method may be repeated at a polling interval which may be, for example, five seconds.

The monitoring energy storage status (201) may include, for example, receiving any one or more of Δ_T, Δ_VVc, Δ_Iv, and I_inst, any of various other data including, but not limited to data of droop control and an analog current sharing signal. The monitoring and receipt of data may be repeated at a polling interval, for example, of five seconds.

The calculation of the BAT_ABUSE_INDEX (202) may include, for example, applying weighting factors (202a) and summing the weighted data (202b), as described according to any of the example embodiments described herein.

The comparison of the BAT_ABUSE_INDEX to a threshold scale (203) may include comparing the summed, weighted data to a threshold and/or threshold scale according to any one or more example embodiments described herein.

If it is determined that the BAT_ABUSE_INDEX is zero (204 – YES), the method may return to the monitoring of the energy storage status. If it is determined that the BAT_ABUSE_INDEX is positive (305 – pos+), indicating, for example, a use of an own battery more aggressively than other converters, the output current may be decreased (206). If it is determined that the BAT_ABUSE_INDEX is negative (205 – neg-), indicating, for example, a use of an own battery less aggressively than other converters, the output current may be increased (207).

Systems and methods according to one or more example embodiments described herein may contribute to the prevention of early failure of the energy storage element(s) used for power smoothing for AI compute loads, giving customers the ability to plan for eventual future replacement, and reducing the need to “touch” the energy storage frequently to measure its health in an attempt to predict upcoming failure. Systems and methods according to one or more example embodiments described herein may also be used for peak shaving on the power grid. A difference, for example, between peak shaving on the power grid and power smoothing is the timescale involved: for example, a time scale of hours for peak shaving and a time scale of seconds or milliseconds for power smoothing.

Power converters which perform “peak shaving” using batteries or supercapacitors these would provide either very long runs of either charging or discharging the energy storage element, or very short discharges at high power followed by long, relatively slow recharge; thus their algorithm for avoiding battery abuse may not need to be very sophisticated. Systems and methods according to one or more example embodiments described herein may contribute to providing a more sophisticated way to maximize the life of the energy storage, and may contribute to an AI compute load smoothing application due to its constant, relatively high frequency, and “symmetrical” (charge as fast as discharging) nature.

Systems and methods according to one or more example embodiments described herein may be integrated into existing converter control algorithms and may share information (e.g. battery temperature sensor readings with other converter control algorithms.

While aspects and implementation of example embodiments have been shown and described herein, it will be understood by those skilled in the art that various changes in form and details may be made therein. For example, various communication protocols can be deployed with various electronic sensors, and/or various visual and/or audio user interfaces can be implemented to facilitate processing and/or displaying information and/or controlling hardware and/or software components of the system.

It may be understood that the example embodiments described herein may be considered in a descriptive sense only and not for purposes of limitation. Descriptions of features or aspects within each example embodiment may be considered as available for other similar features or aspects in other example embodiments.

While example embodiments have been described with reference to the figures, it will be understood by those of ordinary skill in the art that various changes in form and details may be made therein without departing from the spirit and scope as defined by the following claims.

We claim:

1. A power monitoring and management system comprising:
an energy storage unit;
a converter operatively coupled to the energy storage unit; and
a controller operatively coupled to the energy storage unit and the converter, the controller comprising a memory storing instructions thereon and a processor configured to execute the instructions and thereby:
receive data of a plurality of status indicators of the energy storage unit;
calculate an index based on the plurality of status indicators;
compare the index to a threshold value;
control the converter to decrease an output current level in a case in which the index is higher than the threshold value; and
control the converter to increase the output current level in a case in which the index is lower than the threshold value.

2. The system according to claim 1, further comprising:
a monitor system comprising at least one sensor communicatively coupled to the controller and configured to sense at least one of the plurality of status indicators and to transmit data of the at least one of the plurality of status indicators to the controller.

3. The system according to claim 1, wherein:
the plurality of status indicators comprises at least two of: an energy storage element temperature Δ_T, a cell voltage sample variance Δ_VVc, a current sample variance Δ_Iv, and an instantaneous current I_inst; and
calculation of the index comprises weighting each of the plurality of status indicators and summing the weighted status indicators.

4. The system according to claim 3, wherein:
Δ_T is a battery temperature of the energy storage unit less a highest battery temperature averaged over a polling interval;
Δ_VVc is a battery cell voltage variance of the energy storage unit less a highest battery cell voltage variance averaged over the polling interval;
Δ_Iv is a battery current variance of the energy storage unit less a highest battery current variance averaged over the polling interval; and
I_inst is an instant battery current of the energy storage unit less a highest allowable battery current.

5. A power monitoring and management system comprising:
a plurality of energy storage units;
a plurality of converters, each of the plurality of converters operatively coupled to a corresponding one of the plurality of energy storage units;
at least one controller operatively coupled to the plurality of energy storage units and to the plurality of converters, the at least one controller comprising a memory storing instructions thereon and a processor configured to execute the instructions and thereby, for each one of the plurality of converters:
receive data of a plurality of status indicators of a corresponding one of the plurality of energy storage units;
calculate an index based on the plurality of status indicators;
compare the index to a threshold value;
control the converter to decrease an output current level in a case in which the index is higher than the threshold value; and
control the converter to increase the output current level in a case in which the index is lower than the threshold value.

6. The system according to claim 5, further comprising:
a monitor system comprising a plurality of sensors, wherein each of the plurality of sensors is communicatively coupled to one of the plurality of converters and configured to sense at least one of the plurality of status indicators and to transmit data of the at least one of the plurality of status indicators to the at least one controller.

7. The system according to claim 5, wherein:
the plurality of status indicators comprises at least two of: an energy storage element temperature Δ_T, a cell voltage sample variance Δ_VVc, a current sample variance Δ_Iv, and an instantaneous current I_inst; and
calculation of the index comprises weighting each of the plurality of status indicators and summing the weighted status indicators.

8. The system according to claim 7, wherein:
Δ_T is a battery temperature of the energy storage unit less a highest battery temperature averaged over a polling interval;
Δ_VVc is a battery cell voltage variance of the energy storage unit less a highest battery cell voltage variance averaged over the polling interval;
Δ_Iv is a battery current variance of the energy storage unit less a highest battery current variance averaged over the polling interval; and
I_inst is an instant battery current of the energy storage unit less a highest allowable battery current.

9. A power monitoring and management method comprising:
at least one sensor sensing a plurality of status indicators of each of a plurality of energy storage units and transmitting the plurality of status indicators to at least one controller;
for each of the plurality of energy storage units, the controller calculating a corresponding index based on the plurality of status indicators and comparing the index to a threshold value;
for each of the plurality of energy storage units, in a case in which the corresponding index is higher than the threshold value, decreasing an output current level of a converter operatively coupled to the energy storage unit; and
for each of the plurality of energy storage units, in a case in which the corresponding index is lower than the threshold value, increasing an output current level of a converter operatively coupled to the energy storage unit.

10. The method according to claim 9, wherein:
the plurality of status indicators comprises at least two of: an energy storage element temperature Δ_T, a cell voltage sample variance Δ_VVc, a current sample variance Δ_Iv, and an instantaneous current I_inst; and
the calculating the corresponding index comprises weighting each of the plurality of status indicators and summing the weighted status indicators.

11. The method according to claim 10, wherein:
Δ_T is a battery temperature of the energy storage unit less a highest battery temperature averaged over a polling interval;
Δ_VVc is a battery cell voltage variance of the energy storage unit less a highest battery cell voltage variance averaged over the polling interval;
Δ_Iv is a battery current variance of the energy storage unit less a highest battery current variance averaged over the polling interval; and
I_inst is an instant battery current of the energy storage unit less a highest allowable battery current.
